(19) United States
(12) Patent Application Publication
(10) Pub. No.: US 2014/0147691 A1
(43) Pub. Date: May 29, 2014

(54) WOOD PRESERVATIVE FORMULATION

(71) Applicants: David Humphrey, Tullamarine, Victoria (AU); Brett Skewes, Tullamarine, Victoria (AU); Angelo Hrastov, Tullamarine, Victoria (AU); Drago Bagaric, Tullamarine, Victoria (AU); Peter Hausler, Tullamarine, Victoria (AU); Shane McFarling, Tullamarine, Victoria (AU); Greg Jensen, Tullamarine, Victoria (AU); Steve Koch, Tullamarine, Victoria (AU); Noel Koskela, Tullamarine, Victoria (AU); Troy Justice, Tullamarine, Victoria (AU)

(72) Inventors: David Humphrey, Tullamarine, Victoria (AU); Brett Skewes, Tullamarine, Victoria (AU); Angelo Hrastov, Tullamarine, Victoria (AU); Drago Bagaric, Tullamarine, Victoria (AU); Peter Hausler, Tullamarine, Victoria (AU); Shane McFarling, Tullamarine, Victoria (AU); Greg Jensen, Tullamarine, Victoria (AU); Steve Koch, Tullamarine, Victoria (AU); Noel Koskela, Tullamarine, Victoria (AU); Troy Justice, Tullamarine, Victoria (AU)

(73) Assignee: ARCH WOOD PROTECTION PTY LTD, Tullamarine, Victoria (AU)

(21) Appl. No.: 14/130,102

(22) PCT Filed: Jun. 29, 2012
(86) PCT No.: PCT/AU2012/000786

§ 371 Date: Dec. 30, 2013

(30) Foreign Application Priority Data
Jun. 30, 2011 (AU) 2011902592

(51) Int. Cl. A01N 55/02; B27K 3/52; B27K 3/08; A01N 43/653

(52) U.S. Cl. CPC A01N 55/02; A01N 43/653; B27K 3/52; B27K 3/08
USPC 428/541; 514/184; 514/500; 514/461; 514/417; 514/389; 514/359; 514/342; 514/341; 514/493; 514/383; 427/427.7; 427/297; 427/428.01; 427/429; 427/440

(57) ABSTRACT

The present invention relates to a preservative formulation for use in treating wood or other cellulosic materials, said formulation comprising: at least one biocidal metal compound; at least one preservative; and an aqueous carrier, wherein the preservative formulation has an uptake in the sapwood of less than about 220 l/m³ yet achieves substantially full penetration of the sapwood. Preferably, the preservative formulation is copper/tebuconazole in a ratio of about 25/1 w/w; and the wood is around 25 mm in thickness—for instance, decking timber.

### FIELD OF THE INVENTION

The present invention relates to the treatment of wood products and other cellulosic formulations with a preservative formulation. More specifically, the invention relates to the treatment of wood with a waterborne preservative mixture, which gives rise to a low uptake of the preservative.

The invention has been developed primarily for use in treating timber which is used in residential applications. For example, treatment of decking wood with the inventive formulation renders the treated wood resistant to insect and fungal decay over a predetermined period. Although the invention will be described hereinafter with reference to this application, it will be appreciated that it is not limited to this particular field of use.

### BACKGROUND OF THE INVENTION

Any discussion of the prior art throughout the specification should in no way be considered as an admission that such prior art is widely known or forms part of the common general knowledge in the field.

Wood is a staple construction formulation used throughout the world. However, it is prone to degradation from elements including the natural environment, weather events, insects, rot and fire. Accordingly, a range of chemical treatments has been developed to improve the durability and working lifetime of wooden structures.

To treat and prevent infestations, timber is often impregnated with a preservative such as a fungicide or insecticide. The preservative is typically present in a carrier, with the mixture being applied to the surface of the timber, for example by dipping, spraying, brushing or pressure treatment, such that the carrier and preservative are absorbed in to the timber.

The treatment of timber or timber products with preservative compounds involves the introduction of stable chemicals into the cellular structure of the timber. This, in turn, protects the timber from hazards such as fungi, insects and other wood-destroying organisms. Preservative treatments may also include the introduction of chemicals that improve resistance to degradation by fire.

Preservative treatment of wood is often carried out at increased pressure so as to force the liquid preservative solution into the pores of the wood. A vacuum may be applied prior to the introduction of the treatment solution in order to increase penetration. The active chemical agent/s is/are usually dissolved in a “carrier” and the preservative solutions are generally of relatively low viscosity in order to facilitate the penetration of the treatment solution.

Increased penetration of the preservative solution can also be achieved by diffusion, which despite involving less expensive equipment, requires a longer time period and greater levels of stock holding. Diffusion time is also influenced by the initial wood moisture content, especially when dealing with aqueous carriers.

TABLE 1
Minimum preservative retention in penetration zone: Hazard Class 3
(H3), AS1604.1-2010
Light organic solvent preservatives/waterborne

| Preservative | Minimum Retention (TAE, % m/m) |
|---|---|
| CCA | 0.38 |
| Cu + DDAC | Softwood 0.35; Hardwood 0.39 |
| Copper azole | 0.229 |
| Creosote | 8 |
| TBTN or TBTO | 0.08 (tin, vertically exposed); 0.16 (tin, |
| | horizontally exposed) |
| Propiconazole & tebuconazole | 0.06 (total azole) |
| Copper naphthenate | 0.1 (copper) |
| Synthetic pyrethroids | Permethrin 0.02; |
| | Cypermethrin 0.03; |
| | Deltamethrin 0.002; |
| | Bifenthrin 0.0047 |

In Australia, the treatment of timber is covered by the Australian standard “AS 1604.1-2010”. Hazard Class H3 is defined as being for protection against “moderate fungal decay and termite hazard for decking, fascia, cladding, window reveals, and exterior structure timber”. Decking is one such example. The timber is exposed to the weather or not fully protected. It is clear from the ground and the area is well drained and ventilated. H3 treatment is designed to prevent attack by insects, including termites, and decay. Retention is measured in mass/mass (% m/m).

“Penetration” is defined under the H3 Standard as: “All preservative-treated wood shall show evidence of distribution of the preservative in the penetration zone in accordance with the following requirements: (a) If the species of timber used is of natural durability class 1 or 2, the preservative shall penetrate all the sapwood. Preservative penetration of the heartwood is not required; (b) If the species of timber used is of natural durability class 3 or 4, the preservative shall penetrate all of the sapwood and, in addition one of the following requirements shall apply; (bi) Where the lesser cross-sectional dimension is greater than 35 mm, the penetration shall be not less than 8 mm from any surface. Where the lesser cross-sectional dimension is equal or less than 35 mm, the penetration shall be not less than 5 mm from any surface; and (bii) Unpenetrated heartwood shall be permitted, provided that it comprises less than 20% of the cross-section of the piece and does not extend more than halfway through the piece from one surface to the opposite surface and does not exceed half the dimension of the side in the cross-section on which it occurs”.

In order to provide for penetration of the preservative, a carrier must be used. As shown in the Australian Standards, the carriers presently available can be characterised broadly as “water-borne” or “solvent-borne” systems.

A carrier must be capable of providing sufficient penetration of the preservative into the wood, thereby to provide an effective barrier against infestation. Other considerations in the choice of carrier include the desired rate of penetration, cost, environmental, health and safety considerations. A carrier may provide for a “complete penetration” formulation, or for an “envelope penetration” formulation in which a defined migration of one or more preservatives into the wood is achieved.

The preservatives commonly used in timber treatment can be characterised according to the carrier vehicle used to carry preservatives into the timber, and by the active chemicals protecting against the various hazards. The final step in the preservation process is that the solvent must then be removed before the timber is made available for use.

The use of biocidal metal ions in wood preservation is well known. There are also many compounds containing an azole group which are known to possess biocidal properties. Indeed, it is known from WO 93/02557 that a metal compound and a fungicidal compound containing a triazole group may exhibit synergistic fungicidal activity.

It will be understood that the metal compound may be present in a form such that metal ions are free in solution, may form part of a complex, or may be micronised. Similarly, the triazole compound may be free in solution or may be present in the form of a salt or a complex or as a micronised dispersion. For example, the triazole compound could be present in the form of a complex with part of the biocidal metal ion.

Impregnation procedures for timber have usually involved an impregnation procedure where the active agent is carried in a liquid carrier. Sometimes the liquid carrier is water or water based. Alternatively, the liquid carrier may comprise an organic or inorganic solvent.

Light Organic Solvent-borne Preservatives (LOSPs) comprise a light organic solvent, typically white spirit, to carry the preservative into the timber. The solvent is drawn out in the final stages of treatment, with the preservative remaining within the wood. Such preservatives are typically fungicides, having copper, tin, zinc, azoles and pentachlorophenols (PCPs) as major toxicants. Synthetic pyrethroids such as permethrin may be incorporated within the preservative composition if an insect hazard is also present. One principal advantage of LOSP treatment is that the treated timber does not swell, making such treatment quite suitable for “finished” items such as mouldings and joinery. The majority of LOSPs used in wood treatment also contain insecticides and/or waxes so as to give the surface water repellent properties. However, odour and exposure to VOCs (volatile organic compounds) are significant environmental/occupational health and safety issues. Accordingly, whilst effective, LOSP treatments are becoming increasingly undesirable. However, the LOSP procedure does have an advantage in that it does not add moisture back into the timber. Excessive moisture uptake can affect the dimensions of timber.

Water-based systems typically require a significant uptake of any water-based treatment composition in order to provide the required penetration through to the core of the timber. This results in an increase of the moisture content of the timber, which in turn affects the dimensional stability of the timber and may also require that the timber be redried prior to use.

The metal compound may be a compound of any biocidally-active metal including copper, aluminium, manganese, iron, cobalt, nickel, zinc, silver, cadmium, tin, antimony, mercury, lead and bismuth; these may be either used alone or in mixtures. The preferred metals are copper and zinc used alone, in combination with each other or with one or more of the metals listed above. The most preferred metal is copper, particularly as the Cu(II) ion. The metal may be solubilised in the aqueous carrier or micronised.

Inorganic boron compounds have been used to protect the sapwood of susceptible hardwoods against lyctid or “powder post” borers. Such treatment consists of soaking freshly-sawn unseasoned timber in solutions of boron salts. The salts diffuse through the timber, thereby treating it, and after such treatment, the timber is allowed to dry. However, boron salts are readily soluble in aqueous solutions and can be leached relatively easily from the wood once treated. This largely restricts boron-treated timber to interior uses such as flooring or joinery, wherein it is protected from the external environment.

Copper azole can be used in waterborne pressure treatment processes. It is a preservative mixture that contains copper and tebuconazole. Copper azole has been used in Australia as a replacement for chromated copper arsenate (“CCA”) for treatments having external applications.

It is an object of the present invention to overcome or ameliorate at least one of the disadvantages of the prior art, or to provide a useful alternative. The present invention thereby seeks to provide a water-based treatment formulation that provides for a low uptake whilst still meeting the industry-specific standards of active ingredient retention and penetration. The relatively low uptake facilitates a dimensional stability in the treated timber that is typically unattainable using conventional water-based treatments. Moreover, a low uptake of waterborne preservative lessens the need to extensive re-drying (e.g., kiln drying) following treatment. If the product is not kiln dried, there is no need (in the case of decking) to machine after treatment to remove sticker marks, thereby further saving time/cost/waste disposal.

The present invention result in effective penetration for a variety of different biocidally-effective active agents having an antifungal or other biocidal role having surprisingly shorter exposure times, lesser uptake (typically within the range 50 to 220 L/m³) to yield a moisture content of the treated timber of less than 25% and preferably less than 20% w/w. The present invention recognises many different actives can be carried into the wood without the need for resins and/or curing agents in the aqueous carrier. The present invention recognises the option of including a wetting agent and/or surfactant. Preferred actives include fungicides, mouldicides, insecticides and termiticides.

Despite the many and varied techniques for the treatment of wood, there remains a need to satisfy the “dry after” requirement for treated timber, having less than 15% moisture content, whilst achieving the required penetration of active compounds into the wood.

The use of relatively low uptakes within the approximate range of 50 to 220 L/m³ has foreseeable benefits by way of reducing cartage costs and reducing in kiln time such that there is less water to be removed.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

### SUMMARY OF THE INVENTION

According to a first aspect of the present invention there is provided a preservative formulation for use in treating wood or other cellulosic formulations, said formulation comprising: at least one biocidal metal compound; at least one preservative; and an aqueous carrier, wherein said preservative formulation has an uptake in the sapwood of less than about 220 L/m³ and achieves substantially full sapwood penetration (defined by compliance with Australian Standard AS 1604).

The inventive formulation is applicable to timber and other cellulosic materials—and also to wood composites selected from the group consisting of: laminated veneer lumber (LVL), cross-laminated timber (CLT), glue laminated timber (glulam), particle board, plywood, medium density fibreboard (MDF) and oriented strand board (OSB).

In preferred embodiments, the preservative formulation has an uptake in the sapwood of less than about 150 L/m³, preferably less than about 120 L/m³, more preferably less than about 100 L/m³, and most preferably less than about 80 L/m³. The most preferred uptake range is between about 70 and about 150 L/m³.

In a preferred embodiment, the metal compound is a compound of a metal selected from the group consisting of: copper, aluminium, manganese, iron, cobalt, nickel, zinc, silver, cadmium, tin, antimony, mercury, lead and bismuth. Preferably, the metal compound is a compound of copper. More preferably, the copper compound is a copper(II) compound.

In a preferred embodiment, the preservative is selected from the group consisting of: insecticides, termiticides, fungicides, mouldicides, or the like, and mixtures thereof. Preferably the preservative is selected from the group consisting of: synthetic pyrethroids (such as allethrin, bifenthrin, cypermethrin, cyphenothrin, deltamethrin, permethrin, prallethrin, resmethrin, sumithrin, tetramethrin, tralomethrin, transfluthrin, imiprothrin), azoles, triazoles, copper azole-based compounds, organic biocides, thiachloprid, imidachloprid or the like, and mixtures thereof, triazoles, copper azole-based compounds, organic biocides, iodopropynylbuthylcarbamate (IPBC), organic tin compounds such as tributyltin naphthenate (TBTN), organic copper compounds such as copper 8 quinolinolate, copper naphthenate, organic zinc compounds, quaternary ammonium compounds, tertiary ammonium compounds, isothiazolones such as 4,5-dichloro-2-octyl-2H-isothiazol-3-one (DCOIT), boron compounds, 3-benzothien-2-yl-5,6-dihydro-1,4,2-oxathiazine-4-oxide (Bethogard®) and bis-(N-cyclohexyldiazenuimdioxy) copper (“Cu-HDO”)”, and mixtures thereof.

In a preferred embodiment, the preservative is a triazole compound of formulae (I) or (II), below, wherein R₁ represents a branched or straight chain C₁₋₅alkyl group; R₂ represents a phenyl group optionally substituted by one or more substituents selected from halogen, C₁₋₃alkyl, C₁₋₃alkoxy, phenyl and nitro; R₃ is as defined for R₂; and R₄ represents a hydrogen atom or a branched or straight chain C₁₋₅alkyl. Preferably, the triazole compound of formula (I) is tebuconazole (α-[2-(4-chlorophenyl)ethyl]-α-(1,1-dimethylethyl)-1H-1,2,4-triazole-1-ethanol) or hexaconazole (α-butyl-α-(2,4-dichlorophenyl)-1H-1,2,4-triazole-1-ethanol). Most preferably, the triazole compound of formula (I) is tebuconazole.

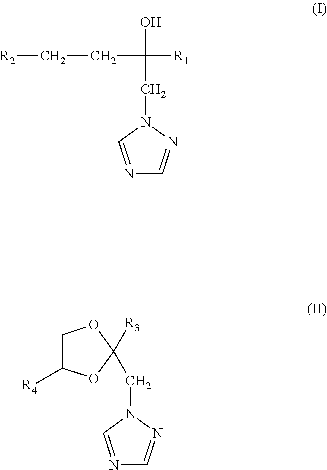

In a preferred embodiment, the triazole compound of formula (II) is propiconazole (1-[[2-(2,4-dichlorophenyl)-4-propyl-1,3-dioxolan-2-yl]methyl]-1H-1,2,4-triazole); azaconazole (1-[[2,4-dichlorophenyl)-1,3-dioxolan-2-yl]methyl]-1H-1,2,4-triazole); or difenaconazole (1-[2-[2-chloro-4-(4-chlorophenoxy)phenyl]-4-methyl-1,3-dioxolan-2-ylmethyl]-1H-1,2,4-triazole).

In a preferred embodiment, the preservative is a triazole compound selected from the group consisting of: azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

In a preferred embodiment, the ratio by weight of said metal to said preservative is between 750:1 and 1:1; preferably between 500:1 and 5:1; more preferably between 100:1 and 10:1; and most preferably about 25:1.

In a preferred embodiment, the aqueous carrier is water, or is substantially water-based (i.e., >90% w/w water). Alternatively, the formulation may further comprise one or more water-miscible compounds selected from the group consisting of: glycerol, propylene glycol, ethylene glycol and the like, and mixtures thereof glycols, amine oxides, quaternary ammonium compounds, glycol ethers, esters, alcohols, phenols, diols, triols, ketones, carbamates, amides, sulfoxides, amines, acids (e.g., amino acids), modified cellulosics or the like, or combinations thereof, polymer/resins (e.g., polyvinyl alcohol), PEGs, water dispersible alkyds, polyesters, proteins, etc. However, more preferably the one or more water-miscible compounds are ethylene glycol or propylene glycol.

In a preferred embodiment, the ratio of water to one or more water-miscible compounds present in the carrier is within the range of about 1:99 to about 99:1 w/w; more preferably within the range of about 5:95 to about 95:5 w/w; more preferably still within the range of about 10:90 to about 90:10 w/w; within the range of about 20:80 to about 80:20 w/w; within the range of about 30:70 to about 70:30 w/w; within the range of about 40:60 to about 60:40 w/w; or most preferably about 50:50 w/w.

In a preferred embodiment, the preservative penetration within said treated wood is by way of substantially complete penetration. Preferably the substantially complete penetration is in accordance with Hazard Class H3 of the Australian Standard AS 1604-2010.

In a preferred embodiment using a co-solvent, the treated wood exhibits a moisture content increase of preferably less than 20% w/w. More preferably the treated wood is classifiable in the art as “dry after” (moisture content <15% w/w) following treatment with said formulation. Preferably the treated wood is substantially not susceptible to leaching of said preservative from said wood. More preferably the treated wood has relatively constant dimensional stability as a result of the carrier remaining within the cells of the treated wood. However, in the preferred embodiment where no co-solvent is used, the moisture content increase will likely exceed the “dry after” standard.

In a preferred embodiment, the treated wood does not require a substantial subsequent drying operation. In an embodiment the formulation is applicable to hardwood and/or softwood species.

In a preferred embodiment, the formulation comprises below about 10% w/w preservative content; preferably below about 5%, more preferably below about 2%; and; more preferably still below about 1% w/w preservative content.

In a preferred embodiment, the biocidal metal compound is present in unmodified or modified form. The modified form preferably comprises a chemical modification providing relatively increased stability against environmental conditions such as heat and/or chemical degradation. The modified form may be a microencapsulated form and/or a micronised form. The formulation may further comprise colour/s, water repellents and/or co-solvents.

According to a second aspect of the present invention there is provided a method of treating a substrate of wood or other cellulosic formulation which comprises applying to the substrate a preservative formulation as defined according to the first aspect of the invention.

Preferably the step of contacting said wood is performed by means selected from the group consisting of: pressure application, spraying, dipping, rolling, painting, or any combination thereof. Preferably, the wood is less than about 25 mm in thickness.

The method preferably comprises at least one vacuum step, more preferably being between about 0 and −50 kPa. The method preferably further comprises at least one pressure step, preferably being between about 0 and 100 kPa. Preferably each said vacuum and/or pressure step is held for between about 0 and 10 minutes.

In a preferred embodiment, the dimensional changes between the wood prior to and post the treatment are no greater than about 2 mm in any or either cross-sectional dimension. In another preferred embodiment a final vacuum step is applied, said final vacuum step taking place when said wood is no longer exposed to said preservative formulation. Preferably the final vacuum step is between about 0 and −95 kPa and is held from about 0 to 60 minutes.

According to a third aspect of the present invention there is provided treated wood, when so-treated by a method defined according to the second aspect of the invention.

According to a fourth aspect of the invention there is provided a method of formulating a formulation for treating wood, said method comprising the step of admixing a preservative mixture defined according to the first aspect of the invention, water and optionally a water-miscible carrier.

According to a fifth aspect of the invention there is provided a formulation for treating wood, when formulated by a method defined according to the fourth aspect of the invention.

According to a sixth aspect of the invention there is provided a saleable kit adapted for re-treating a fatigued wood that has been treated previously with a preservative formulation, said kit comprising: a predetermined volume of a formulation as defined according the first aspect of the invention; application means in the form of a brush, sprayer or roller; and instructions as to how to re-treat said fatigued wood.

According to a seventh aspect of the invention there is provided a saleable kit adapted for treating an untreated wood, either on-site or in-situ, said kit comprising: a predetermined volume of a formulation as defined according to the first aspect of the present invention; application means in the form of a brush, sprayer or roller; and instructions as to how to treat said wood.

The kits of the sixth and seventh aspects of the invention are envisaged as “buy-off-the-shelf” kits that the “home handyman” can purchase—and then take home, either to re-treat fatigued wood such as decking (fatigued wood will presumably be in situ), or fresh/virgin wood (which can foreseeably be treated either before use or in situ). Treatment of wood in situ negates (or at least makes difficult) the use of pressure/vacuum gradients, meaning that the low-uptake preservative formulation is to be applied by conventional means such as spraying, brushing rolling or in some circumstances, dipping.

The Applicant has found that compositions according to the present invention possess advantageous properties. In particular, the metal compound and the fungicidal compound containing the triazole group (hereinafter, “the triazole compound”) may exhibit synergistic fungicidal activity.

It will be understood that the metal compound may be present in a form such that metal ions are free in solution or may form part of a complex. Similarly, the triazole compound may be free in solution or may be present in the form of a salt or a complex. For example, the triazole compound could be present in the form of a complex with part of the biocidal metal ion.

The compositions according to the invention may be used to treat substrates such as wood or other cellulosic formulations (such as cotton, hessian, rope and cordage). For convenience, the invention will be described hereinafter with reference to the treatment of wood, but it will be appreciated that the other formulations may be treated analogously.

The metal compound may be a compound of any biocidally-active metal including copper, aluminium, manganese, iron, cobalt, nickel, zinc, silver, cadmium, tin, antimony, mercury, lead and bismuth. These may be either used alone or in mixtures. The preferred metals are copper and zinc used alone, in combination with each other or with one or more of the metals listed previously. The most preferred metal is copper, particularly Cu(II) ion.

The triazole compound may be any compound which contains a triazole group and which possesses biocidal activity. Preferably, the triazole compound contains the triazole group (A)

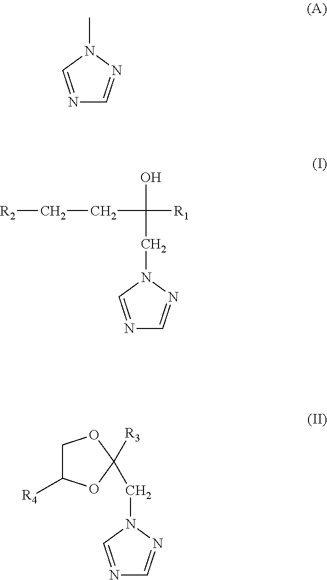

Advantageously, the triazole compound is selected from compounds of formula (I) wherein R₁ represents a branched or straight chain C₁₋₅alkyl group (e.g., t-butyl) and R₂ represents a phenyl group optionally substituted by one or more substituents selected from halogen (e.g., chlorine, fluorine or bromine) atoms and C₁₋₃alkyl (e.g., methyl), C₁₋₃alkoxy (e.g., methoxy), phenyl and nitro groups. A particularly preferred compound of formula (I) is tebuconazole: α-[2-(4-chlorophenyl)ethyl]-α-(1,1-dimethylethyl)-1H-1,2,4-triazole-1-ethanol (i.e., R₁=butyl; R₂=p-chlorophenyl).

Alternatively, the triazole compound is advantageously selected from compounds of formula (II) wherein R₃ is as defined for R₂ above; and R₄ represents a hydrogen atom or a branched or straight chain C₁₋₅alkyl group (e.g., n-propyl). Particularly preferred compounds of formula (II) are propiconazole: 1-[[2-(2,4-dichlorophenyl)-4-propyl-1,3-dioxolan-2-yl]methyl]-1H-1,2,4-triazole (i.e., R₃=o,p-dichlorophenyl; R₄=n-propyl); and azaconazole: 1-[[2,4-dichlorophenyl)-1,3-dioxolan-2-yl]methyl]-1H-1,2,4-triazole (i.e., R₃=o,p-dichlorophenyl; R₄=H).

The inventive compositions may contain more than one triazole, compound for example, they may contain tebuconazole and propiconazole, or a mixture of tebuconazole, propiconazole and azaconazole. Compositions may contain more than one triazole compound. For example, they may contain tebuconazole and propiconazole, or a mixture of tebuconazole, propiconazole and azaconazole.

The Inventors have found that the biocidal metal may advantageously be incorporated into the composition in the form of inorganic salts of the metal ion, e.g., in the form of the metal carbonate, sulfate, chloride, hydroxide, borate, fluoride or oxide. Alternatively, the metal may be used in the form of the metal salt of a simple organic compound, e.g., in the form of a salt of a carboxylic acid such, as a metal acetate. Thus, it has been found that the biocidal triazole compounds exhibit synergistic properties when the metal ion is present in the form of such simple salts, and it is not necessary to add the metal ion in the form of a salt of, or complex with, a larger more complex organic compound which itself possesses biocidal properties. Alternatively, the metal may be in micronised form.

The optimum weight ratio of metal ion to triazole compound varies depending on the particular formulation or product to which the composition is applied and the type of organism against which protection is required. Preferably, the ratio by weight of metal to triazole compound is less than 1000:1, through to, especially about 25:1 w/w.

The concentration required for preservative treatment depends on the ratio of metal to triazole compound selected, the metal chosen, the method of treatment employed, the timber species, the level of protection required and the nature and quantity of any other biocides present. The levels necessary can be determined readily by one skilled in the art. In general, the level of metal required will be in the range 0.01-5% and the level of triazole will be in the range 25 ppm to 1.0%. The preferred range for waterborne treatments is to have a metal concentration of 0.1-5% and a triazole level of 50 ppm to 5000 ppm.

Compositions in accordance with the invention may if desired additionally contain nitrite ion. Alternatively, there can be advantages associated with the omission of nitrite ion from the compositions. For example, by leaving out nitrite ion the formation of certain noxious gases is prevented.

The compositions of the present invention may advantageously contain a biocidally-active quaternary ammonium compound or tertiary amine salt. These compounds aid in the formation of emulsions of triazole compounds in aqueous solutions of biocidal metal ion.

Compositions containing quaternary ammonium compounds or tertiary amine salts can form microemulsions which are particularly useful in the treatment of timber. In addition, the presence of these compounds may mean that additional organic solvents are not necessary to solubilise the triazole compound. Furthermore, the quaternary ammonium compounds and tertiary amine salts are themselves biocidal and so they enhance the overall biocidal activity of the composition. These compounds also improve penetration of the biocidal metal ion and triazole compound into the timber.

The composition in accordance with the invention comprises water as solvent/carrier. Formulations can be prepared as concentrates intended to be diluted at the treatment facility, or the formulations can be prepared in the form of dilute treatment solutions. Optionally, separate solutions of biocidal metal ion and triazole compound can be provided, e.g., in the form of two concentrates intended to be mixed before or after dilution.

Suitable formulations may be prepared, for example, by preparing aqueous solutions of metal ion complexes and subsequently adding an emulsified formulation of the triazole compound. Suitable complexing agents for the metal ion would be for example, polyphosphoric acids such as tripolyphosphoric acid, ammonia, water soluble amines and alkanolamines capable of complexing with biocidal cations; aminocarboxylic acids such as glycine, glutamic acid, ethylenediaminetetraacetic acid, hydroxyethyldiamine triacetic acid, nitrilotriacetic acid and N-dihydroxy ethylglycine; polymeric compounds which contain groups capable of complexing with metallic cations such as polyacrylic acids; hydroxycarboxylic acids such as tartaric acid, citric acid, malic acid, lactic acid, hydroxybutyric acid, glycollic acid, gluconic acid and glucoheptonic acid; phosphonic acids such as nitrilotrimethylene phosphonic acid, ethylenediaminetetra(methylenephosphonic acid), hydroxyethylidene diphosphonic acid. Where the complexing agents are acidic in nature they may be employed either as free acids or as their alkali metal or ammonium salts. These complexing agents may be used either alone or in combination with each other.

Suitable surfactants for triazole compounds include, for example, cationic, nonionic, anionic or amphoteric surfactants.

Suitable formulations can also be prepared, for example, by adding an emulsified formulation of the triazole compound to an aqueous solution of a metal salt, such as copper sulphate or zinc acetate. At high ratios of metal ion to azole, the solubility of the azole may be sufficient to disperse the azole in the formulation using a suitable co-solvent.

Alternatively, formulations can be prepared employing only organic solvents. To prepare such formulations, a biocidal metal salt of a carboxylic acid (e.g., decanoic or octanoic acid) is prepared and dissolved in a suitable organic solvent to form a concentrate. The triazole compound can then be added directly to the concentrate or to a solution diluted with a suitable solvent such as an ester, alcohol, ester alcohol, aliphatic or aromatic hydrocarbon, glycol ether, glycol or ketone.

Concentrated formulations containing organic solvents can be diluted with water to form an emulsion which can be stabilised with surfactants if necessary.

Compositions in accordance with the invention can optionally contain other additives conventionally employed in timber preservation such as water repellents, colour additives, viscosity modifiers or corrosion inhibitors.

The compositions of the invention may contain other organic compounds including fungicides, mouldicides, termiticides, insecticides and bacteriocides. Such organic compounds include carboxylic acids such as naphthenic acids and branched aliphatic acids and their metal salts such as copper and zinc naphthenate, phenols and substituted phenols such as orthophenyl phenol and its alkali metal or ammonia salts or dichlorophen (2,2′-methylene-bis(4-chlorophenol)); polyhalogenated phenols such as pentachlorophenol or tribromophenol and their alkali metal or ammonia salts; quaternary ammonium salts and tertiary amine salts such as didecyl dimethyl ammonium chloride, octyl decyl dimethyl ammonium chloride, dodecyl dimethyl benzyl ammonium chloride, dodecyl benzyl trimethyl ammonium chloride, dodecyl dimethyl amine acetate, dodecyl dimethyl amine lactate, dodecyl dimethyl amine salicylate, didodecyl methyl amine chloride; isothiazolone derivatives such as 4,5-dichloro-2-(n-octyl)-4-isothiazolin-3-one or 2-methyl-4-isothiazolin-3-one, 2-n-octyl-4-isothiazolin-3-one and mixtures of those and other related compounds; sulfamide derivatives such as N,N-dimethyl-N-phenyl-(N-fluorodichloro-methylthio)-sulfonamide, N,N-dimethyl-N-tolyl-N-(dichlorofluoro-methylthio)-sulfamide; azoles such as imidazole; fungicides such as fludioxinil and cyprodinil; MBT (methylene-bis thiocyanate); IPBC (3-iodo-2-propanyl-butyl-carbamate); carbendazim and chlorothalonil; N-nitrosophenylhydroxylamine and N-nitroso cyclohexyl hydroxylamine, either as their metal salts or as metal chelates; pyrethroid type insecticides selected from the group consisting of cyano-(4-fluoro-3-phenoxyphenyl)-methyl-3-(2,2-dichloroethenyl)-2,2-dimethyl cyclopropanecarboxylate, (3-phenoxyphenyl)methyl-3-(2,2-dichloro-ethyenyl)-2,2-dimethyl-cyclopropanecarboxylate, cyano-(3-phenoxy-phenyl)-methyl-2-(4-chlorophenyl)-3-methylbutyrate, and mixtures thereof; organo-phosphorous, carbamate and organochlorine insecticides such as lindane.

Other biocidally-active elements may also be present such as boron, in any form, for example boric acid, boron or boron esters and also fluorides and silicafluorides.

Particularly preferred compositions in accordance with the invention comprise copper(II) ion, a triazole compound which is tebuconazole or propiconazole, and optionally an alkanolamine, as well as optionally borate ion and/or a quaternary ammonium compound or a mixture of quaternary ammonium compounds.

According to a further form of the present invention there is provided a method of treating timber or another cellulosic substrate of the type hereinbefore described, which comprises applying to the substrate a composition as defined above.

The skilled person will be well acquainted with the various methods of treating the substrates with aqueous solutions. For example, the compositions according to the invention may be applied to wood by dipping, spraying, deluging, brushing, vacuum impregnation, pressure impregnation and/or any other applicable method. Other types of substrate may be treated by analogous methods.

The following non-limiting Examples further illustrate the invention. The Examples suggest an uptake of around 120 L/m³ for decking that is 22 mm thick. Thicker profiles may require higher uptakes.

Copper azole preservatives (e.g., Cu/tebuconazole; 25/1), unlike chromated copper arsenate (CCA) does not rely on chromium to fix the active ingredients. When very low uptake processes such as Lowry or Reuping are used with CCA there is a high risk of sludge formation. This is as a result of high preservative “kickback” including water soluble wood extractives. This kickback solution can result in hexavalent chromium converting to trivalent chromium and hence producing sludge in the preservative. This problem is further exacerbated by high ambient temperature. Copper azole does not use chromium fixation and is temperature stable. With this in mind, very low uptake processes were trialled using diluted copper azole. Surprisingly it was found that satisfactory penetration (and retention) could be achieved with a copper azole preservative at low uptake. The use of very low uptakes will have benefits in reducing cartage costs and reducing in kiln time because there is less water to be removed.

In the following Examples, copper azole concentrate containing copper and tebuconazole, was diluted with water (and optionally ethylene glycol). The formulation was subjected to accelerated storage stability testing (+54° C./2 weeks & 0° C./1 week), and by chemical analysis was shown to be stable under both sets of conditions. The ethylene glycol content could be varied between 0 and 80% and the formulation remained stable.

### BRIEF DESCRIPTION OF THE FIGURES

A preferred embodiment of the invention will now be described with reference to the accompanying Figures, in which:

FIG. 1 is an image of cross-section of samples treated in Example 3, after cutting and application of a copper spot rest reagent. The dark green/black coloration indicates the presence of copper.

FIG. 2 is an image of cross-section of specimens treated in Example 4, after cutting and application of a copper spot rest reagent/heartwood indicator.

FIG. 3 depicts copper penetration as shown by application of copper indicator (rubeanic acid), in 140×45 mm radiata pine treated with particulate copper azole preservative.

### EXAMPLE 1

Copper azole concentrate, containing copper and tebuconazole in a ratio of 25/1, was diluted with water to produce a homogeneous solution containing 0.9% w/w copper. Radiata pine sapwood decking, 70×22 mm in cross-section (28 sections), was treated using a Lowry schedule. The schedule consisted of flooding the vessel, applying a positive pressure of +80 kPa for 5 minutes, emptying the vessel and applying a vacuum (−85 kPa) for 15 minutes.

TABLE 2
Summary of results of treatment (Example 1)

| Mean uptake | 118 L/m³ |
|---|---|
| Mean change in width | +2.5 mm |
| Mean change in moisture content | +24% |
| Mean sapwood penetration | 93% |

The individual specimen uptakes were determined by weighing each specimen before and after treatment. The swelling was also measured, using a digital micrometer. After drying, the specimens were cut and penetration determined by applying a copper indicator. The results are summarised in Table 2. Satisfactory penetration was achieved at greatly reduced uptake.

### EXAMPLE 2

Matched sets of radiata pine decking (90×22 mm) from a different source to that used in Example 1, were treated with Tanalith® E (i.e., Cu/tebuconazole; 25/1) diluted with water; each set consisted of 32 replicates. Several schedules, all similar to those used in Example 1, were trialled. The schedules differed in pressure and time at pressure. It was found that satisfactory treatment could be achieved at a mean uptake of 124 L/m³. Individual specimen uptakes, moisture content increase, swelling (width only) and retention/penetration were determined. Results are summarised in Table 3.

TABLE 3
Summary of results of treatment (Example 2)

| Mean uptake | 124 L/m³ |
|---|---|
| Mean change in width | +2.8 mm |
| Mean change in moisture content | +24% |
| Mean copper retention | 0.22% m/m Cu |
| Mean sapwood penetration | 96% |

### EXAMPLE 3

This Example incorporates a water-miscible co-solvent. Tanalith® E (i.e., Cu/tebuconazole; 25/1) concentrate (16% w/w of final solution) was diluted with ethylene glycol (50% w/w of final solution) and water (34% w/w of final solution). The ethylene glycol content could be varied between 0 to 80% and the formulation remained stable.

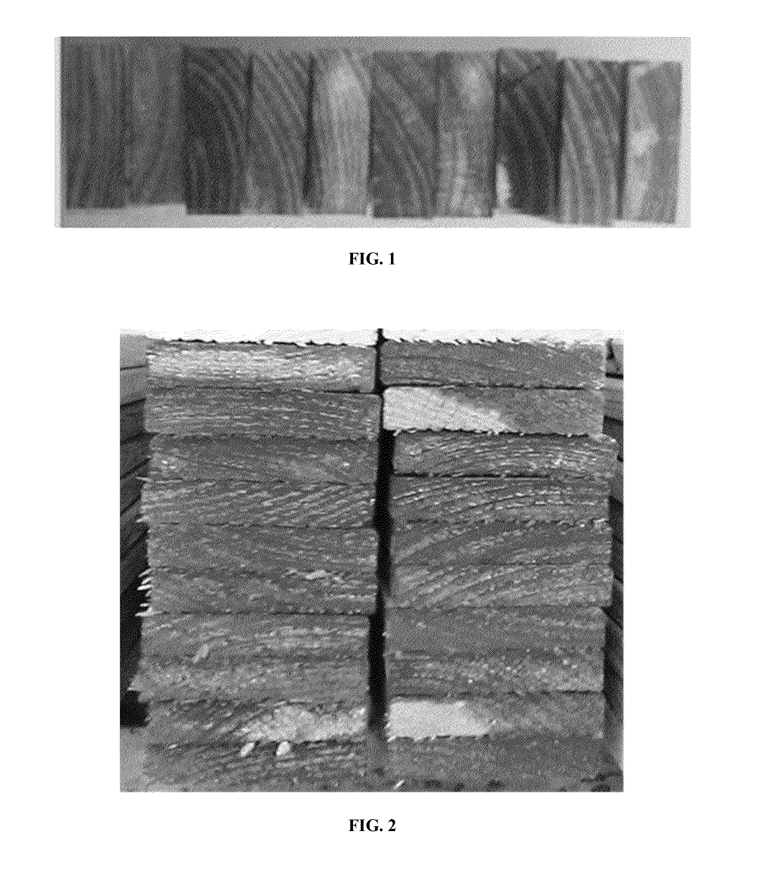

The use of such a formulation to treat radiata pine decking is illustrated here. Satisfactory treatment was obtained, and no redrying was required.
Substrate: Kiln dried radiata pine sapwood (dressed all round), 70×25 mm. Ten replicates, end sealed.
Treatment: Flood, +80 kPa (3 min), drain, vacuum (−85 kPa, 20 min).
Mean uptake: 87 L/m³.
Moisture content: 15.8%
Penetration: >90% (as judged by application of a copper spot test, refer to FIG. 1).
Volumetric swelling: 3.2%

### EXAMPLE 4

Radiata pine decking (70×22 mm) was treated with Tanalith® E (i.e., Cu/tebuconazole; 25/1) concentrate diluted in water. Some specimens in this Example contained heartwood. It was found that satisfactory treatment for this resource could be achieved with a Lowry process, at a mean uptake of 120 L/m³.

### EXAMPLE 5

Eight matched samples of radiata pine were prepared. The samples included complete sapwood, complete heartwood and mixed samples. All samples were end sealed with araldite prior to treatment. Six treatments were used with the Tanalith® E (i.e., Cu/tebuconazole; 25/1) preservative.
1. Bethell (−85 kPa 5 min; 1400 kPa 20 min; −85 kPa 15 min)
2. Modified Bethell (−35 kPa 5 min; 450 kPa 20 min; −85 kPa 15 min).
3. Lowry (300 kPa 20 min; −85 kPa 15 min)
4. Lowry (450 kPa 20 min; −85 kPa 15 min)
5. Lowry (450 kPa 60 min; −85 kPa 15 min)
6. Reuping (100 kPa air 5 min; 450 kPa 30 min; −85 kPa 15 min)

Samples were measured for volume prior to treatment and weights before and after treatment taken to give uptake. Preservative penetration was by cutting samples and testing for copper penetration using rubeanic acid and ammonia. Table 4 gives a summary of data collected during treatments. Charge 1 shows the very high uptakes associated with Bethell full cell treatment. The use of a modified Bethell process reduced the sapwood uptake to 352 L/m³. The experimental treatments involved low pressure Lowry and Reuping schedules.

TABLE 4
Uptake and penetration results from sapwood treatments (Example 5)

| | Sapwood Uptake | Ratio to | Sapwood |
|---|---|---|---|
| Process | L/m³ | Bethell | penetration |
| 1. Bethell | 629 | 1.00 | 100% |
| 2. Mod Bethell | 352 | 0.56 | 100% |
| 3. Lowry | 257 | 0.41 | 100% |
| 4. Lowry | 236 | 0.38 | 100% |
| 5. Lowry | 249 | 0.40 | 100% |
| 6. Reuping | 205 | 0.33 | 100% |

If these processes were used with CCA then there would be a high sludge potential. The low pressure Lowry schedules gave considerably lower uptakes than the modified Bethell schedule while not compromising sapwood penetration. Time on pressure and maximum pressure do not appear to greatly affect uptake. Using a low pressure Reuping schedule further reduced the sapwood uptake; complete sapwood penetration was again achieved.

Table 5 shows uptakes for heartwood in the charges. It has always been problematic to achieve similar uptakes in heartwood compared to sapwood. This has meant in many cases that the sapwood must be well over-treated to a obtain acceptable levels in the heartwood.

TABLE 5
Uptake results from heartwood treatments of Example 5

| | Heartwood Uptake | |
|---|---|---|
| Process | L/m³ | Ratio Heartwood:Sapwood |
| 1. Bethell | 217 | 0.34 |
| 2. Mod Bethell | 91 | 0.26 |
| 3. Lowry | 149 | 0.58 |
| 4. Lowry | 86 | 0.36 |
| 5. Lowry | 91 | 0.36 |
| 6. Reuping | 70 | 0.34 |

Heartwood penetration was not spectacular in any of the treatments, with the Bethell process giving best penetration as would be expected. All other processes gave similar heartwood penetration.

The best ratio for heartwood and sapwood uptakes was achieved by a Lowry process where the pressure was held for 60 minutes at 450 kPa. Previous research has shown that a key to heartwood penetration is time on pressure as well as pressure applied. It must not be forgotten that the ability to penetrate heartwood is very much dependant on how the wood is dried. Central plateau wood from the North Island of New Zealand is relatively easy to penetrate compared with old logs from the Mt Gambier region of Australia.

### EXAMPLE 6

Larger cross-sectioned timbers can also be treated at reduced uptake. End-sealed sections of kiln-dried radiata pine (140×45 mm in cross-section) were treated with a 5.9% w/w Tanalith® E (i.e., Cu/tebuconazole; 25/1) diluted with water. The treatment schedule utilised +220 kPa of pressure for 15 minutes, followed by a vacuum (−85 kPa, 20 minutes) after removal of the preservative solution from the specimens. At the completion of the vacuum cycle, the specimens were drip-free. The mass of the specimens was recorded before and after treatment to determine uptake. The mean uptake over the ten specimens was 143 L/m³, with the lowest and highest individual specimen uptakes being 95 and 186 L/m³, respectively. When the specimens were dry, they were sectioned and copper indicator (rubeanic acid) applied to the freshly cut face to determine penetration. Even in this large cross-section, satisfactory penetration was achieved (>90%).

### EXAMPLE 7

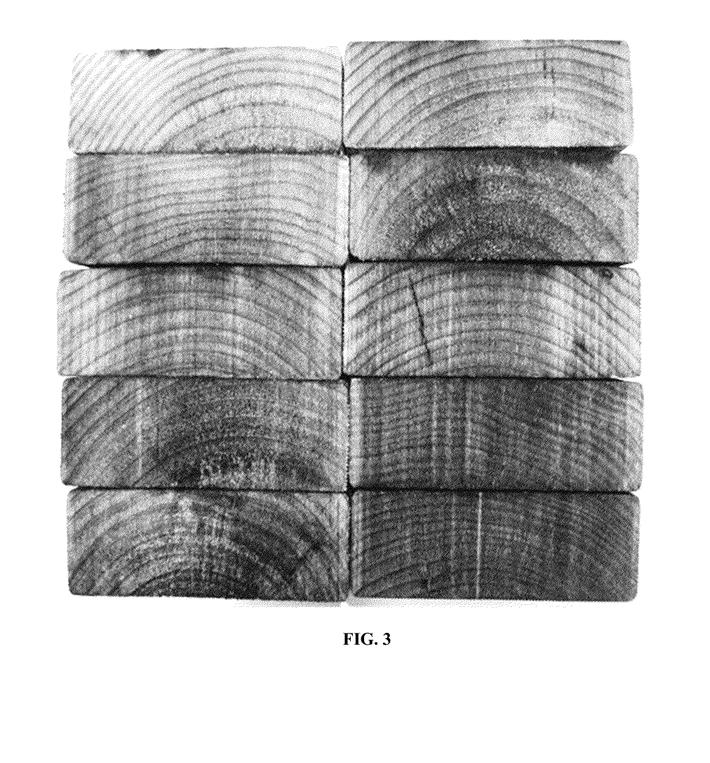

In a further example, it was found that low uptake treatments using a particulate (or micronised) copper azole preservative were also practical. The details of the treatment are summarised in Table 6, below, and an image of the cut specimens after application of copper indicator is shown in FIG. 3.

TABLE 6
Summary of particulate Cu/Az treatment of radiata pine (Example 7)

| Preservative | Particulate copper azole, 5.9% w/w |
|---|---|
| | (product concentration) |
| Substrate | End-sealed 140 × 45 mm radiata pine |
| Treatment schedule | +220 kPa 15 minutes/−85 kPa 20 minutes |
| Average uptake (L/m³) | 178 (lowest individual = 129, highest |
| | individual = 216) |
| Penetration | 10/10 |

The particulate copper azole preservative was comprised of a fine dispersion of basic copper carbonate suspended in water, in combination with an emulsified form of tebuconazole (the ratio of copper to tebuconazole was 25 to 1). A set of ten radiata pine specimens (140×45 mm in cross-section), matching those specimens used in Example 6, were treated with the particulate copper azole preservative using the same schedule as used in Example 6. Again, satisfactory penetration was achieved, at an uptake of 178 L/m³.

### EXAMPLE 8

To demonstrate the commercial applicability of the invention, 4.8 m radiata pine decking (90×22 mm) was treated with a copper azole preservative in a large scale trial. Thirty pre-weighed decking boards (average basic density 412 kg/m³) were loaded into a treatment cylinder, the cylinder flooded with the copper azole work solution over a period of 7 minutes, then pressurised at +200 kPa for 15 minutes. At the completion of the pressure cycle, the cylinder was emptied of preservative liquid and a vacuum applied (−85 kPa) for a further 10 minutes. The decking was removed from the cylinder and was found to be drip-free. The decking boards were re-weighed and the mean uptake was found to be 96 L/m³. The width of the decking was also recorded before and after treated and the average width increase was found to be 2.33 mm. After treatment, the decking boards were cross-cut and copper indicator (rubeanic acid) applied, and the penetration assessed as being acceptable.

### EXAMPLE 9

In another example, the penetration of soluble copper azole (Tanalith® E) and copper quaternary ammonium salt (ACQ) preservatives were compared. The results are summarised in Table 7, below.

TABLE 7
Summary of results from Example 9

| Preservatives | Tanalith ® E | ACQ |
|---|---|---|
| Active ingredients | Copper, tebuconazole | Copper, didecyldimethyl- |
| | | ammonium chloride |
| Product solution | 10.1% w/w | 14.1% w/w |
| strength | | |
| Treatment schedule | +100 kPa, 5 min; | +80 kPa, 3 min; −90 kPa, |
| | −90 kPa, 20 min | 20 min |
| Average uptake (L/m³) | 95 | 103 |
| Penetration | >80% | <80% |

Matched sets of end-sealed 90×35 mm radiata pine were treated with the two preservatives to approximately the same uptake, targeting “Hazard Class 3” active retentions for the respective products as listed in the Australian standard AS 1604.1-2010.

In general, the uptake for ACQ is higher when the same process is applied, so that different processes must be used to obtain similar uptakes. The mass of each specimen was recorded before and after treatment to determine uptake, and copper penetration was assessed after the specimens had dried by cutting the specimens in half and applying a copper indicator (rubeanic acid) to the freshly cut surface. It was found that the copper penetration with the copper azole preservative was greater than that for ACQ.

### EXAMPLE 10

An alternative copper azole preservative can be prepared by combining copper naphthenate (6% copper in hydrocarbon solvent), tebuconazole dissolved in a glycol co-solvent, triethanolamine and water.

TABLE 8
Formulation applied in Example 10

| Component | % w/w |
|---|---|
| Copper naphthenate (6% elemental copper) | 9.52 |
| Tebuconazole | 0.02 |
| Hexylene glycol | 30.6 |
| Triethanolamine | 9.75 |
| Water | Balance |

In summary, very low uptakes can be achieved using processes which would normally be excluded when using CCA type preservatives. Tanalith® E, because of its unique formulation and fixation mechanism can safely be used with these modified processes. The real benefit from these low uptakes is less weight for cartage and more rapid re-drying in kilns.

The formulation of the present invention can be applied to the wood by a wide range of methods, such as pressure-vacuum application, spraying, dipping, rolling, painting, or combinations thereof. The formulation is preferably applied by combinations of vacuum and pressure. The inventive formulation can also be applied to all relevant species of wood, i.e., hardwood and softwood, as well as engineered wood products such as plywood, laminated veneer lumber and oriented strand board. Most preferably, the formulation is applicable to pinus spp. used in residential decking. The sapwood uptake of the preservative formulation by the wood being treated is expectably less than about 220 L/m³, more preferably less than about 100 L/m³, more preferably still, less than about 80 L/m³.

Depending upon the ratio of water:glycol in the formulation, which is preferably about 40:60, 30:70, 20:80, 10:90, 50:50, 60:40, 70:30, 80:20 or 90:10% w/w, the moisture content increase of the wood can be limited to between around 3 to 5% w/w. The water-miscible carrier (e.g., glycol) acts as an inert agent and limits moisture content increase. The glycol, as is known from the art, further acts as a “bulking” agent that enters the cell wall and gives relatively “permanent” swelling of the wood and a reasonable level of dimensional stability. Further, water causes swelling of the cell structure of the wood through chemical bonding with the cellulose fibres, thereby forcing them apart. Such swelling is largely reversible as the wood dries, but nonetheless requires significant energy. Further, such reversibility occurs generally only below the fibre saturation point. Glycols are also known to swell wood. However, such swelling is deemed to be “permanent” as the energy required to reverse this chemical bonding with glycols is excessively large.

It will be appreciated that the illustrated water-based formulation used in the treatment of wood achieves required penetration of the wood with non-water-miscible actives that are stable in the water-based formulation while also being relatively non-toxic and relatively environmentally-friendly. It will be further appreciated that the inventive formulation substantially overcomes or ameliorates many of the disadvantages inherent in using known water-based carriers. These operational advantages are due to the “permanent” swelling of the wood by the glycol carrier such that leaching of the actives out of the wood is largely avoided, a re-drying step is not necessary, and the dimensional stability of the treated wood is maintained.

Although the invention has been described with reference to specific examples it will be appreciated by those skilled in the art that the invention may be embodied in many other forms.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

In the description provided herein, numerous specific details are set forth. However, it is understood that embodiments of the invention may be practiced without these specific details. In other instances, well-known methods, structures and techniques have not been shown in detail in order not to obscure an understanding of this description. Thus, while there has been described what are believed to be the preferred embodiments of the invention, those skilled in the art will recognise that other and further modifications may be made thereto without departing from the spirit of the invention, and it is intended to claim all such changes and modifications as fall within the scope of the invention. For example, any formulas given above are merely representative of procedures that may be used. Steps may be added or deleted to methods described within the scope of the present invention.

It will be appreciated that wood treated according to the present invention may be characterised by a “dry after” requirement for treated timber, having less than 15% moisture content, whilst achieving the required penetration of active compounds into the wood.

1. A preservative formulation for treating wood or other cellulosic materials, said formulation comprising:
at least one biocidal metal compound;
at least one preservative; and
an aqueous carrier being water,
one or more water-miscible co-solvents,
wherein said preservative formulation has an uptake in the sapwood of less than about 220 L/m³ and achieves substantially full sapwood penetration thereby facilitating maintenance of dimensional stability of the wood or other cellulosic materials being treated.

2. A formulation according to claim 1, wherein said preservative formulation has an uptake in the sapwood of less than about 150 L/m³, or in the range of about 70 to about 150 L/m³.

3. A formulation according to claim 1, wherein said preservative formulation has an uptake in the sapwood of less than about 120 L/m³.

4. A formulation according to claim 3, wherein said preservative formulation has an uptake in the sapwood of less than about 100 L/m³.

5. A formulation according to claim 4, wherein said preservative formulation has an uptake in the sapwood of less than about 80 L/m³.

6. A formulation according to claim 1, wherein said metal compound is a compound of a metal selected from the group consisting of: copper, aluminium, manganese, iron, cobalt, nickel, zinc, silver, cadmium, tin, antimony, mercury, lead and bismuth.

7. A formulation according to claim 1, wherein said metal compound is a compound of copper.

8. A formulation according to claim 7, wherein said copper compound is a copper (II) compound.

9. A formulation according to claim 1, wherein said preservative is selected from the group consisting of: insecticides, termidicides, fungicides, mouldicides, or the like, and mixtures thereof.

10. A formulation according to claim 1, wherein said preservative is selected from the group consisting of: synthetic pyrethroids (such as allethrin, bifenthrin, cypermethrin, cyphenothrin, deltamethrin, permethrin, prallethrin, resmethrin, sumithrin, tetramethrin, tralomethrin, transfluthrin, imiprothrin), azoles, triazoles, copper azole-based compounds, organic biocides, thiachloprid, imidachloprid or the like, and mixtures thereof, triazoles, copper azole-based compounds, organic biocides, iodopropynylbuthylcarbamate (IPBC), organic tin compounds such as tributyltin naphthenate (TBTN), organic copper compounds such as copper 8 quinolinolate, copper naphthenate, organic zinc compounds, quaternary ammonium compounds, tertiary ammonium compounds, isothiazolones, boron compounds, 3-benzothien-2-yl-5,6-dihydro-1,4,2-oxathiazine-4-oxide (Bethogard®) and bis-(N-cyclohexyldiazenuimdioxy) copper (“Cu-HDO”), and mixtures thereof.

11. A formulation according to claim 10, wherein said preservative is a triazole compound of formulae (I) or (II): 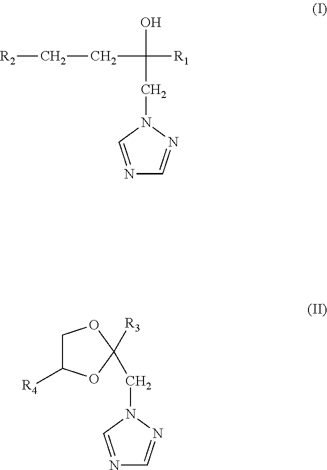
wherein R₁ represents a branched or straight chain C₁₋₅alkyl group; R₂ represents a phenyl group optionally substituted by one or more substituents selected from halogen, C₁₋₃alkyl, C₁₋₃alkoxy, phenyl and nitro; R₃ is as defined for R₂; and R₄ represents a hydrogen atom or a branched or straight chain C₁₋₅alkyl.

12. A formulation according to claim 10, wherein said triazole compound of formula (I) is tebuconazole (α-[2-(4-chlorophenyl)ethyl]-α-(1,1-dimethylethyl)-1H-1,2,4-triazole-1-ethanol) or hexaconazole (α-butyl-α-(2,4-dichlorophenyl)-1H-1,2,4-triazole-1-ethanol).

13. A formulation according to claim 12, wherein said triazole compound of formula (I) is tebuconazole.

14. A formulation according to claim 10, wherein said triazole compound of formula (II) is propiconazole (1-[[2-(2,4-dichlorophenyl)-4-propyl-1,3-dioxolan-2-yl]methyl]-1H-1,2,4-triazole); azaconazole (1-[[2,4-dichlorophenyl)-1,3-dioxolan-2-yl]methyl]-1H-1,2,4-triazole); or difenaconazole (1-[2-[2-chloro-4-(4-chlorophenoxy)phenyl]-4-methyl-1,3-dioxolan-2-ylmethyl]-1H-1,2,4-triazole).

15. A formulation according to claim 10, wherein said preservative is a triazole compound selected from the group consisting of: azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, and uniconazole-P.

16. A formulation according to claim 1, wherein the ratio by weight of said metal to said preservative is between 750:1 and 1:1.

17. A formulation according to claim 16, wherein the ratio by weight of said metal to said preservative is between 500:1 and 5:1.

18. A formulation according to claim 17, wherein the ratio by weight of said metal to said preservative is between 100:1 and 10:1.

19. A formulation according to claim 18, wherein the ratio by weight of said metal to said preservative is about 25:1.

20. A formulation according to claim 1, wherein said aqueous carrier is water.

21. A formulation according to claim 1, wherein one or more water-miscible co-solvents are selected from the group consisting of: glycerol, propylene glycol, ethylene glycol, amine oxides, quaternary ammonium compounds, glycol ethers, esters, alcohols, phenols, diols, triols, ketones, carbamates, amides, sulfoxides, amines, organic acids and combinations thereof.

22. A formulation according to claim 21, wherein said one or more water-miscible co-solvents are ethylene glycol or propylene glycol.

23. (canceled)

24. (canceled)

25. A formulation according to claim 21, wherein the ratio of water to one or more water-miscible co-solvents is within the range of about 10:90 to about 90:10 w/w.

26. A formulation according to claim 25, wherein the ratio of water to one or more water-miscible co-solvents is within the range of about 20:80 to about 80:20 w/w.

27. A formulation according to claim 26, wherein the ratio of water to one or more water-miscible co-solvents is within the range of about 30:70 to about 70:30 w/w.

28. A formulation according to claim 27, wherein the ratio of water to one or more water-miscible co-solvents is within the range of about 40:60 to about 60:40 w/w.

29. A formulation according to claim 28, wherein the ratio of water to one or more water-miscible co-solvents is about 50:50 w/w.

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. A formulation according to claim 1, wherein said biocidal metal compound is in modified form is a microencapsulated form and/or a or micronised form.

45. (canceled)

46. (canceled)

47. (canceled)

48. A method of treating a substrate of wood or other cellulosic materials, which method comprises contacting said wood or other cellulose materials with a formulation including:
at least one biocidal metal compound;
at least one preservative; and
an aqueous carrier being water,
one or more water-miscible co-solvents,
wherein said preservative formulation has an uptake in the sapwood of less than about 220 L/m³ and achieves substantially full sapwood penetration thereby facilitating maintenance of dimensional stability of the wood or other cellulosic materials being treated.

49. A method according to claim 48, wherein said step of contacting said wood is performed by means selected from the group consisting of: pressure application, spraying, dipping, rolling, painting, or any combination thereof.

50. A method according to claim 48, wherein said wood is less than about 25 millimetres in thickness.

51. A method according to claim 48, further comprising at least one vacuum step.

52. (canceled)

53. A method according to claim 48, further comprising at least one pressure step.

54. (canceled)

55. (canceled)

56. A method according to claim 48, wherein dimensional changes between the wood prior to and post the treatment are no greater than about 2 mm in any or either cross-sectional dimension.

57. (canceled)

58. (canceled)

59. (canceled)

60. (canceled)

61. Treated wood or other cellulosic material, comprising wood or other cellulosic material having impregnated therein with a formulation including:
at least one biocidal metal compound;
at least one preservative; and
an aqueous carrier being water,
one or more water-miscible co-solvents,
wherein said preservative formulation has an uptake in the sapwood of less than about 220 L/m³ and achieves substantially full sapwood penetration thereby facilitating maintenance of dimensional stability of the wood or other cellulosic materials being treated.

62. (canceled)

63. (canceled)

64. (canceled)

65. (canceled)

66. (canceled)

67. (canceled)

68. (canceled)

69. (canceled)

70. (canceled)
